(19) United States
(12) Patent Application Publication
(10) Pub. No.: US 2008/0137237 A1
(43) Pub. Date: Jun. 12, 2008

(54) MAGNETORESISTIVE SENSOR HAVING A HARD BIAS BUFFER LAYER, SEED LAYER STRUCTURE PROVIDING EXCEPTIONALLY HIGH MAGNETIC ORIENTATION RATIO

(75) Inventors: James Mac Freitag, Sunnyvale, CA (US); Mustafa Michael Pinarbasi, Morgan Hill, CA (US)

Correspondence Address: ZILKA-KOTAB, PC- HIT, P.O. BOX 721120, SAN JOSE, CA, 95172-1120, US

(73) Assignee: HITACHI GLOBAL STORAGE TECHNOLOGIES

(21) Appl. No.: 11/609,784

(22) Filed: Dec. 12, 2006

(51) Int. Cl. G11B 5/127

(52) U.S. Cl. 360/324.12

(57) ABSTRACT

A magnetoresistive sensor having magnetically anisotropic bias layers for biasing the free layer of the sensor. The sensor includes a sensor stack with a pinned layer structure and a free layer structure and having first and second sides. Hard bias structures for biasing the magnetization of the free layer are formed at either side of the sensor stack, and each of the hard bias structure includes a hard magnetic layer that has a magnetic anisotropy to enhance the stability of the biasing. The hard bias layer is formed on a buffer layer and a seed layer, the seed layer being sandwiched between the buffer layer and the hard bias layer. The buffer layer has an anisotropic surface texture that promotes the magnetic anisotropy in the hard bias layer. The buffer layer can be CrMo or Ru or can be a bi-layer including a layer of CrMo with a layer of Ru over the CrMo. The seed layer can be constructed of a material having a BCC structure and is preferably constructed of CrMo.

### FIELD OF THE INVENTION

The present invention relates to free layer biasing in a magnetoresistive sensor, and more particularly to a magnetically anisotropic hard bias layer formed over a treated buffer-layer/seed-layer structure.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk and when the disk rotates, air adjacent to the surface of the disk moves along with the disk. The slider flies on this moving air at a very low elevation (fly height) over the surface of the disk. This fly height is on the order of Angstroms. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. This sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is biased parallel to the ABS, but is free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos ⊖, where ⊖ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

A parameter that is critical to proper sensor performance is that stability of the free layer biasing. Free layers can have their magnetizations biased by hard magnetic layers (hard bias layer) formed at either side of the sensor. A magnetic bias field from the bias layer, which is magnetostatically coupled with the free layer, keeps the magnetization biased in a desired direction parallel with the air bearing surface (ABS). However, as sensors become ever smaller, they become inherently unstable. In current and future spin valve designs, traditional biasing mechanisms are insufficient to ensure reliable, robust biasing. As a result, such sensors suffer from excessive signal noise, to the point where such sensors become impractical.

Therefore, there is a strong felt need for a structure or method that can be employed to ensure or enhance free layer biasing even in very small sensors. Such a structure or method would preferably provide free layer biasing that is robust and well controlled, while still allowing for sufficient free layer sensitivity.

### SUMMARY OF THE INVENTION

The present invention provides a magnetoresistive sensor having a magnetically anisotropic hard bias structure for free layer biasing. The bias structure includes a buffer layer having an anisotropic surface texture and a seed layer formed over the buffer layer. A hard magnetic layer (hard bias layer) is formed over the seed layer. The anisotropic surface texture of the buffer layer causes a highly desirable magnetic anisotropy in the above hard bias layer.

The buffer layer may be a layer of CrMo or a layer of Ru. The buffer layer also may be constructed as a bi-layer structure including a first sub-layer constructed of CrMo and a second sub-layer constructed of Ru formed over the first sub-layer. The seed layer can be CrMo, and the hard bias layer can be CoPt or CoPtCr.

As mentioned above, the anisotropic surface texture of the buffer layer induces a desired magnetic anisotropy in the hard bias layer. This magnetic anisotropy greatly enhances the robustness and stability of the hard bias layer, in addition, the presence of the seed layer over the buffer layer ensures the growth of a hard bias layer with high Hc, high magnetic anisotropy and a high squareness ratio.

The anisotropic surface texture can be formed on the buffer layer by directing a low power angled ion beam at the surface of the buffer layer prior to deposition of the seed layer. This angled ion milling can be performed at an angle of about 30-85 degrees with respect to normal, and can be performed while the sensor and wafer are held on a stationary chuck.

The present invention can be embodied in either a giant magnetoresistive sensor (GMR), either current in plane (CIP) or current perpendicular to plane (CPP), or in a tunnel junction sensor (TMR) also referred to as a tunnel valve. While the invention is described below as a CIP GMR sensor, it should be pointed out that that this is for purposes of example. The invention can be embodied in a tunnel valve, and would be very effective for use in a tunnel valve.

These and other advantages and features of the present invention will he apparent upon reading the following detailed description in conjunction with the Figures.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 3-3 of FIG. 2, illustrating the location of a magnetic head thereon;

FIG. 3 is an ABS view of a magnetic sensor according to an embodiment of the present invention taken from circle 3 of FIG. 2;

FIG. 4 is an ABS view of a magnetoresistive sensor according to an alternate embodiment of the invention;

FIG. 5 is a an ABS view of a magnetoresistive sensor according to another embodiment of the invention;

FIGS. 6-9 are ABS cross sectional views of a magnetoresistive sensor shown in various intermediate stages of manufacture illustrating a method of manufacturing a sensor according to the embodiment as illustrated with reference to FIG. 3;

FIG. 10 is a cross sectional view illustrating a method of forming an anisotropic texture on a surface in order to induce a magnetic anisotropy in a material deposited thereon;

FIG. 11 is a perspective view of the method of forming an anisotropic texture on a surface in order to induce a magnetic anisotropy in a material deposited thereon; and

FIG. 12 is a cross sectional view illustrating an anisotropic texture on a surface that might be formed by the method illustrated in FIGS. 10 and 11.

### BEST MODE FOR CARRYING OUT THE INVENTION

The following description is of the best embodiments presently contemplated for carrying out this invention. This description is made for the purpose of illustrating the general principles of this invention and is not meant to limit the inventive concepts claimed herein.

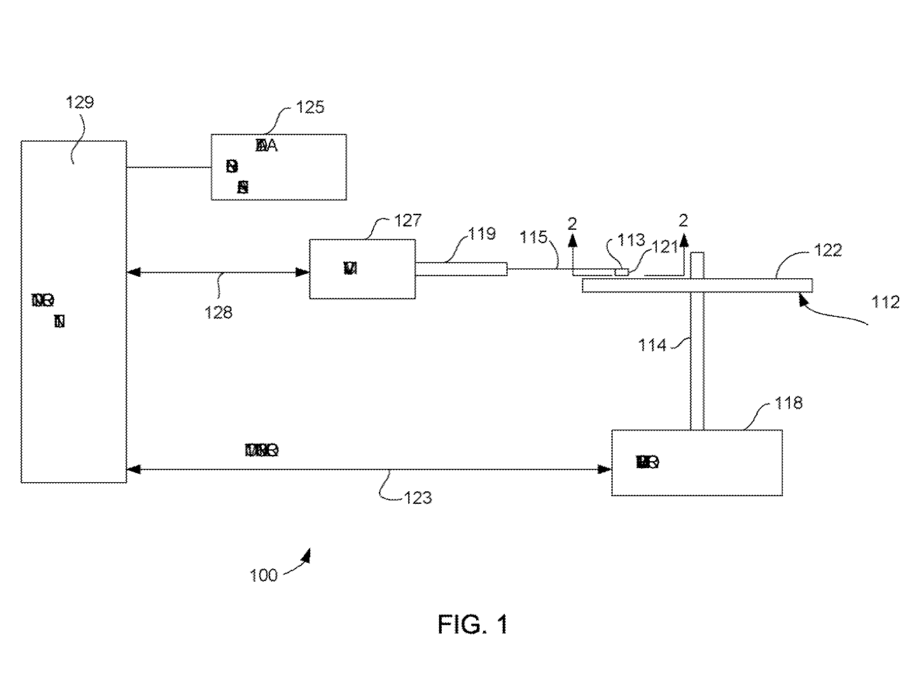

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

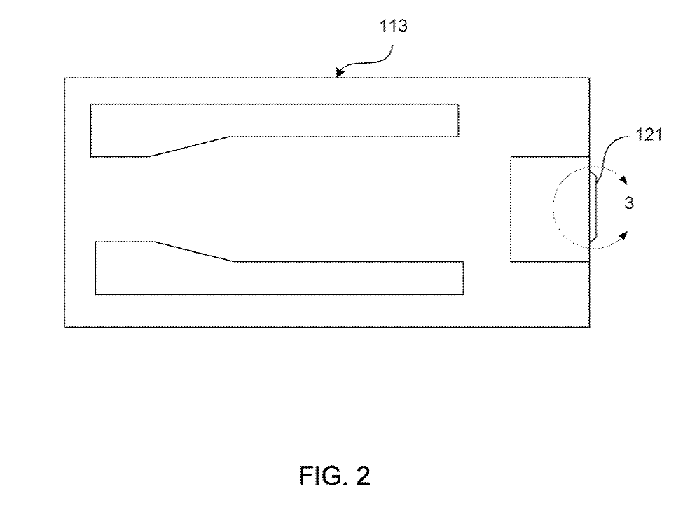

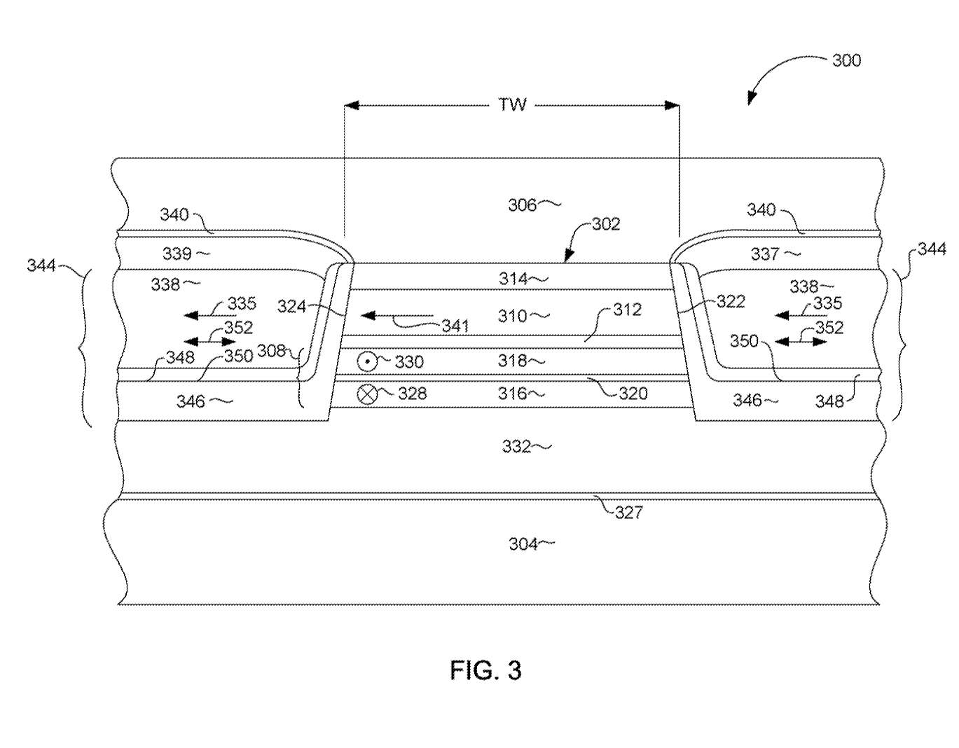

With reference to FIG. 2, the orientation of the magnetic head 121 in a slider 113 can be seen in more detail. FIG. 3 is an ABS view of the slider 113, and as can be seen the magnetic head including an inductive write head and a read sensor, is located at a trailing edge of the slider. The above description of a typical magnetic disk, storage system, and the accompanying illustration of FIG. 1 are for representation purposes only. It should be apparent that disk storage systems may contain a large number of disks and actuators, and each actuator may support a number of sliders.

With reference now to FIG. 3, a magnetoresistive sensor 300 according to an embodiment of the invention includes sensor stack 302 sandwiched between first and second gap layers 304, 306. The sensor stack 302 includes a magnetic pinned layer structure 308 and a magnetic free layer 310. A non-magnetic, electrically conductive spacer layer 312, such as Cu, is sandwiched between the free layer 310 and the pinned layer structure 308. A capping layer 314, such as Ta, may be provided at the top of the sensor stack 302 to protect the sensor from damage during manufacturing, such as from corrosion during subsequent annealing processes.

The pinned layer 308 can be a simple pinned structure or an antiparallel (AP) pinned structure and is preferably an AP pinned structure including first and second magnetic layers (AP1) 316, and (AP2) 318 which may be for example CoFe antiparallel coupled across a thin AP coupling layer 320 such as Ru. The free layer 310 can be constructed of various magnetic materials such as NiFe or CoFe, and may include layers of CoFe and NiFe, preferably with a layer of CoFe or Co adjacent to the spacer 312 for optimal sensor performance.

As can be seen with reference to FIG. 3, the sensor stack 302 has first and second laterally opposed side walls 322, 324 that define the track-width or active area of the sensor. A layer of antiferromagnetic material (ATM) 332 such as PtMn or IrMn formed at the bottom of the sensor stack 302 is exchange coupled with the AP1 layer 316. The AFM layer, when exchange coupled with the AP1 layer 316 strongly pins the magnetic moment of the AP1 layer 316 as indicated by arrowhead 328. This in turn strongly pins the moment 330 of the AP2 layer 318 by antiparallel exchange coupling across the AP coupling layer 320. The AFM layer 332 may be formed on a seed layer 327 constructed of a material that is chosen to initiate a desired crystallographic structure in the AFM layer 332.

With continued reference to FIG. 3, the sensor 300 includes first and second hard magnetic, bias layers (HB layers) 338. In addition, first and second leads 337, 339 are formed over the HB layers 338. The leads 337, 339 may be constructed of, for example, Ta, Au, Rh or some other electrically conducting material. A capping layer 340 such as Ta may be formed over the leads 337, 339 to protect the underlying layers during manufacture. The HB layers 338 can be constructed of various hard magnetic materials and are preferably constructed of CoPt or an alloy containing Co, Ft and Cr, more specifically Co₈₀ Pt₁₂ Cr₈. The hard bias layers 338 have a high magnetic coercivity and are magnetized in a desired direction as indicated by arrows 335. The hard bias layers 338 are magnetostatically coupled with the free layer 310 to bias the magnetization of the free layer 310 in a direction parallel with the ABS as indicated by arrow 341.

With reference still to FIG. 3, the sensor can be constructed as either a full mill design, where the sides 322, 324 of the sensor stack extend all of the way down to the gap layer 332, or could be a partial mill design as shown wherein a portion of the sensor layers such as the AFM 332 or pinned layer 308 extend beyond the active area of the sensor. The use of either design is made possible by a novel hard bias buffer/seed layer structure as will be described below.

With reference still to FIG. 3, the read head 300 includes a hard bias structure 344 that includes the hard magnetic bias layer 338 previously discussed. The sensor structure 344 also includes a buffer layer 346 and a seed layer 348 formed over the buffer layer 346, such that the seed layer 348 is disposed between the buffer layer 346 and the hard bias layer 338.

The buffer layer 346 interrupts the crystallographic structure of the underlying layer (in this case the AFM 332). This allows the bias structure 344 to be constructed over a crystalline material of a layer of the sensor stack 302 such as in a partial mill sensor design, without the crystalline structure of the underlying layer 332 negatively affecting the magnetic properties of the above applied hard bias layer 338. Therefore, the presence of the buffer layer allows the sensor structure to be effectively used in either a full mill or partial mill design.

The buffer layer can be constructed, of material such as Ru or CrMo, and may have a thickness of 10 to 150 Angstroms or about 40 Angstroms. The buffer layer has a surface 350 that has been treated to form it with an anisotropic surface texture. This anisotropic surface texture (formed by a method that will be discussed in greater detail herein below) results in a desired magnetic anisotropy 352 in the above hard bias layer 338. This magnetic anisotropy 352 greatly enhances the robustness and stability of the magnetic bias field 335 provided by the hard bias layer 338.

The seed layer 348, formed over the buffer layer 346 can be constructed of a material having a body centered cubic (BCC) crystalline structure, and is preferably constructed of CrMo. The seed layer 348 may have a thickness of 10-200 Angstroms. The presence of the seed layer 348 over the buffer layer 346 allows the above hard magnetic bias layer 338 to maintain a high magnetic coercivity while still exhibiting the magnetic anisotropy 352 provided by the anisotropic surface texture of the underlying buffer layer 346. Using the above described treated Ru buffer layer 346 and treated surface layer 350, the hard magnetic bias layer 338 has a magnetic coercivity of 1150 Oe, while also having a squareness ratio of 3:4. The squareness ratio is the ratio of the squareness of the easy axis with respect to the hard axis and gives an indication of the amount of magnetic anisotropy of the magnetic layer. With a CrMo buffer layer and a similar treatment, a high coercivity of greater than 1836 Oe can be achieved, but the squareness ratio will be reduced to about 1:3.

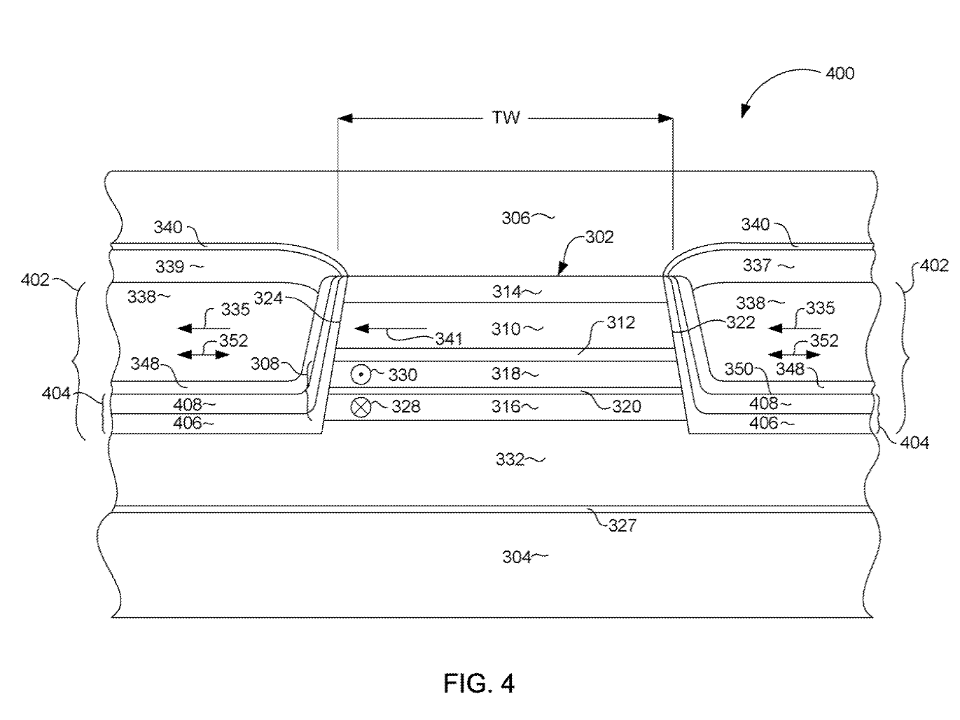

With reference now to FIG. 4, an alternate embodiment of the invention includes a bias structure 402 having a bi-layer buffer layer 404. The bi-layer buffer layer 404 has a first sub-layer 406, which can be constructed of for example CrMo with a thickness of 10-150 Angstroms. The bi-layer buffer layer 404 also includes a second sub-layer 408 formed over the first sub-layer 406. The second sub-layer 408 can be constructed of, for example, Ru, which can have a thickness of 10-150 Angstroms. Therefore, the bi-layer buffer layer 404 could have a total thickness of 20-300 Angstroms.

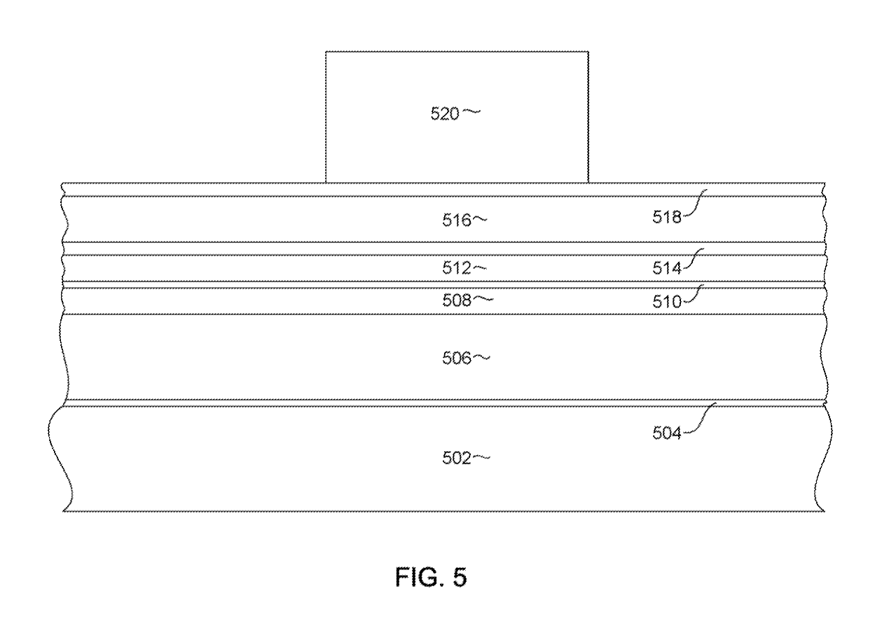

FIGS. 5-9 illustrate a method for constructing a sensor such as that described above with reference to FIGS. 3 and 4. With particular reference to FIG. 5, a substrate 502 is provided. This substrate may be an alumina gap layer or some other non-magnetic material. A seed layer 504 such as Ta can be deposited over the substrate 502, followed by a layer of antiferromagnetic material 506 such as PtMn or IrMn. Then, a first magnetic layer (AP1) 508 is deposited followed by anon-magnetic anti parallel coupling layer such as Ru 510 followed by a second magnetic layer (AP2) 512. Then, a non-magnetic electrically conducive spacer layer such as Cu 514 is deposited over the second magnetic layer 512, followed by a third magnetic layer (free layer) 516 and a capping layer such as Ta 518. A mask structure 520 is then formed over the deposited layers 502-518. The mask structure 520 can include a photoresist or thermal image resist that has been photolithographically patterned and developed to have a width to define a track width of the sensor. The mask can also include one or more hard mask layers such as alumina (Al₂O₃) or silicon dioxide as well as image transfer layer such as a soluble polyimide such as DURIMIDE®.

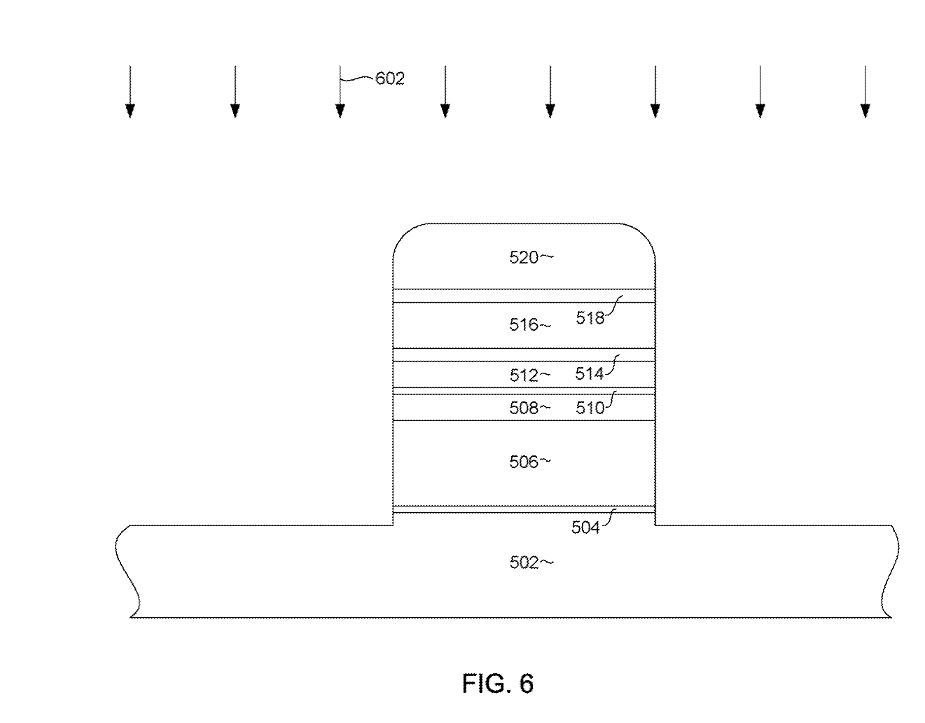

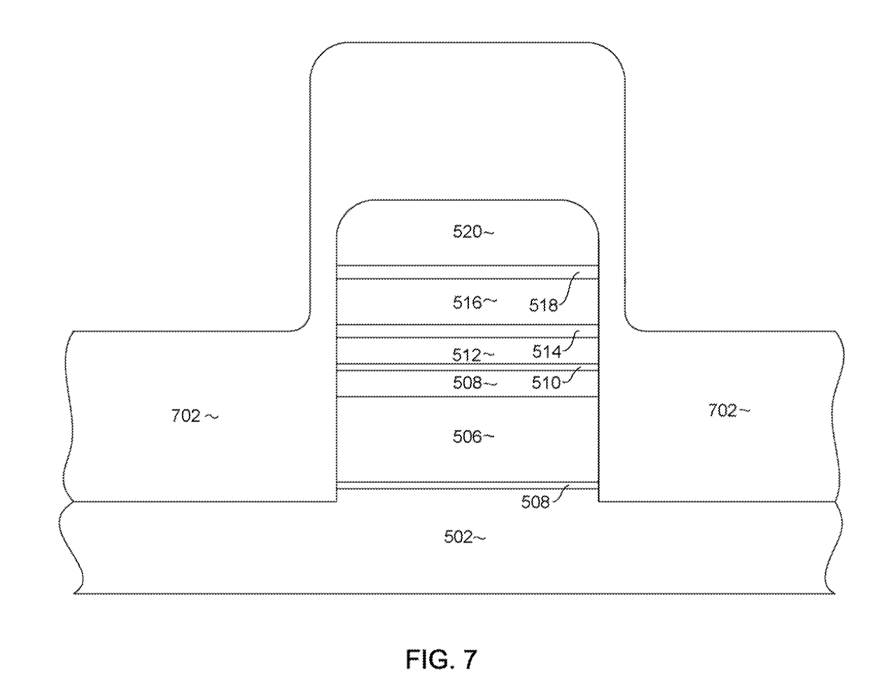

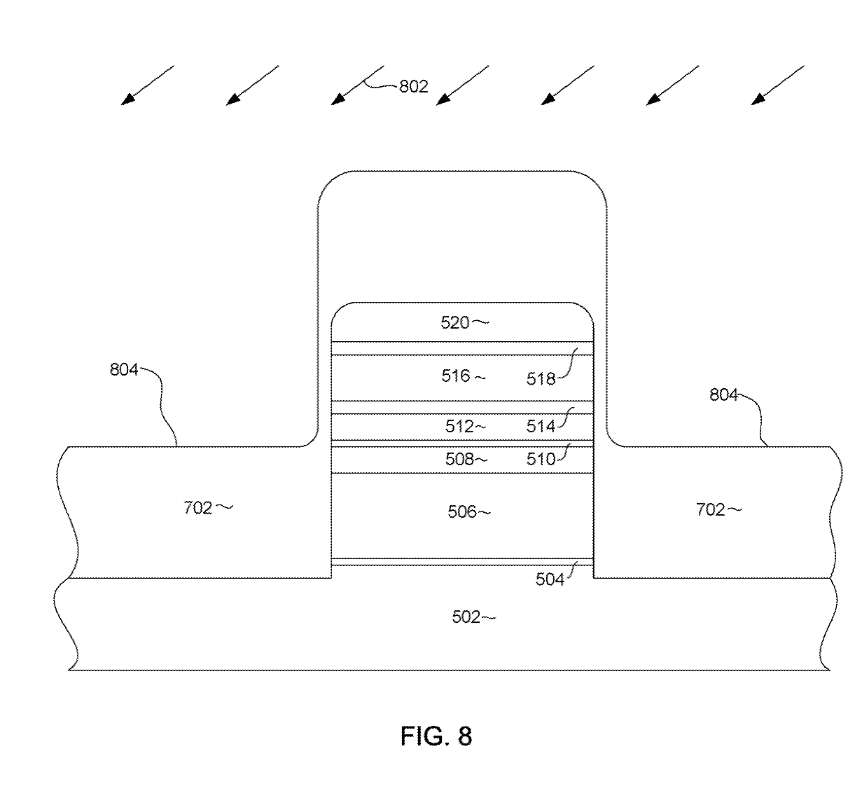

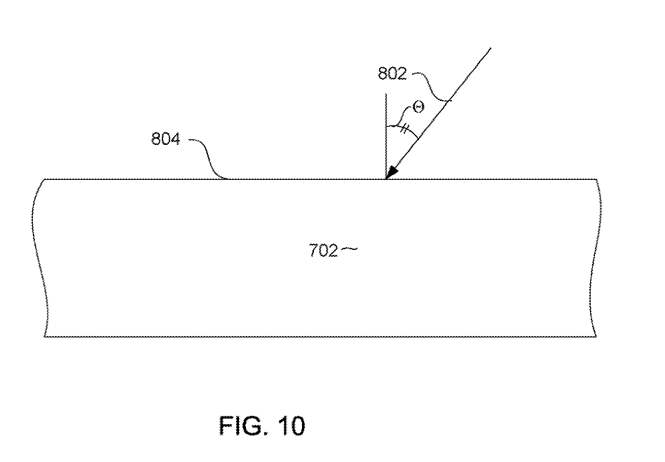

Then, with reference to FIG. 6, a material removal process such as ion milling is performed, using an ion beam 602 to remove portions of the sensor layers 504-518 that are not covered by the mask 520. Then, with reference to FIG. 7 a buffer layer material 702, is deposited. The buffer layer material 702 can be CrMo or Ru or can be a bi-layer including a layer of CrMo with a layer of Ru deposited over the layer or CrMo. With reference to FIG. 8, a surface treatment is performed by directing an angled ion beam 802 at the deposited buffer layer 702 to create an anisotropic texture on the surface of the buffer layer 702. The angled ion milling can be performed by directing the ion beam 802 at an angle of about 60 degrees (30-85 degrees) relative to normal. This angled ion milling will be described in greater detail below with reference to FIGS. 10-12. The buffer layer 702 is deposited to such a thickness that after the angled ion milling treatment, the buffer layer will have a desired thickness. For example, the buffer layer can be deposited to a thickness of 30-170 Angstroms or about 90 Angstroms. The angled ion milling may then remove about 20 Angstroms of the buffer layer 702, leaving a buffer layer having a thickness of 10-150 Angstroms or about 60 Angstroms.

As will be understood by those skilled in the art, the layers 502-520 and 702 are deposited on a structure formed on a wafer that is held on a chuck within a tool such as a sputter deposition tool. The angled ion milling is performed by directing the angled ion beam 802 onto the surface 804 of the buffer layer 702 while the chuck is held stationary. In other words the angled ion milling is not a sweeping ion mill and is not performed while rotating the chuck. However, because of shadowing from the substantially tall sensor stack structure (layers 506-520), the ion milling 802 may only be able to etch the buffer layer 702 on one side of the sensor stack at regions close to the sensor stack. Therefore, in order to effectively treat the buffer layer 702 on both sides of the sensor stack and improve within wafer uniformity, the ion milling can preferably be performed as a two step process, by performing a first in milling, then rotating the chuck 180 degrees, and then performing a second ion milling.

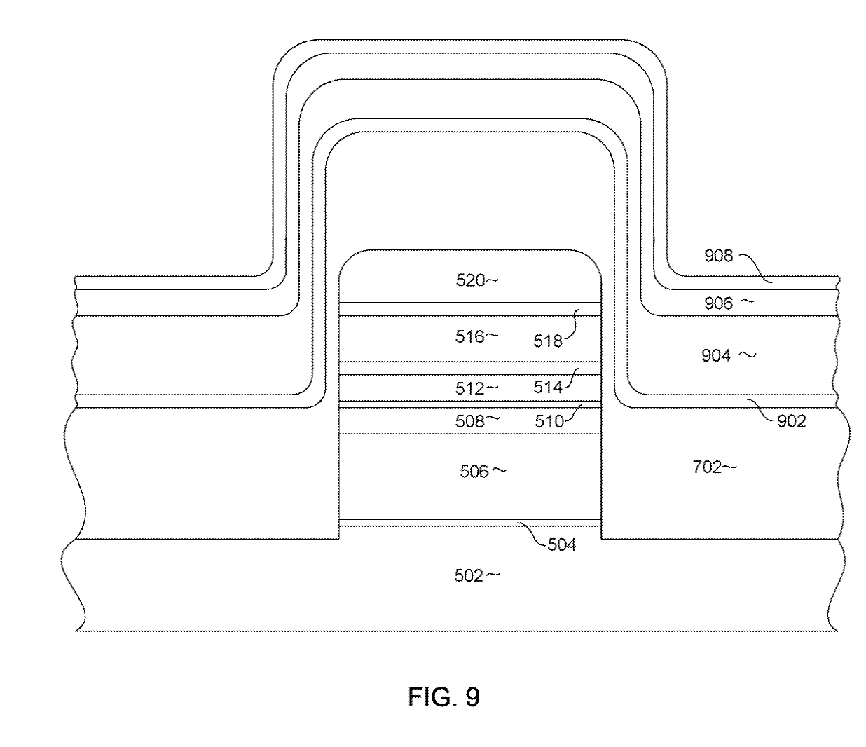

With reference now to FIG. 9, a CrMo seed layer 902 is deposited over the buffer layer 702. The seed layer 902 can be various thicknesses but is preferably deposited to a thickness of 10 to 200 Angstroms or about 50 Angstroms. Then, a layer of hard magnetic material having a high magnetic coercivity 904 is deposited over the seed layer 902. The hard magnetic material 904 can be CoPt or CoPtCr. An electrically conductive lead material 906 such as Au, Rh or Cu can then be deposited over the hard magnetic material 904. Then, a capping layer 908 such as Ta can be deposited over the lead 906. After the various layers have been deposited, a chemical mechanical polishing process (CMP) or other similar process can be performed to remove the mask 520 from over the sensor area and to remove the layers 702, and 902-908 protruding upward over the mask 520. Then, a non-magnetic gap material such as alumina (not shown) can be deposited to form the structure described with reference to FIG. 3.

Although, the above embodiments have been described with reference to a current-in-plane (CIP) giant magnetoresistive (GMR) sensor, it should be pointed out that this is by way of example only. The enhanced free layer biasing provided by the present invention can be employed in many other types of sensors. For example, the biasing enhancements described above could be employed in a current perpendicular to plane (CPP) GMR sensor or in a tunnel valve (TMR).

With reference to FIGS. 10-12, a surface treatment used to form an anisotropic roughness on the surface 804 of the buffer layer 702 will be described in greater detail. With particular reference to FIG. 10, the buffer layer 702 is deposited. A low power ion milling is then performed by directing an ion beam 802 at an angle Θ of less than 90 degrees (preferably 30-85 degrees or about 60 degrees) with respect to a normal to the surface 804 of the buffer layer 702 (or with respect, to the wafer, not shown). The ion milling 802 is preferably performed at a voltage of 20-500 Volts or about 50 Volts.

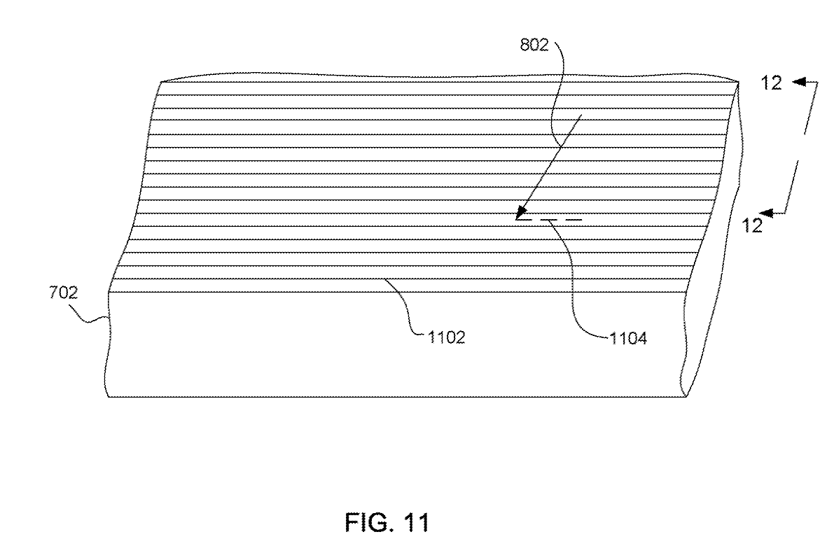

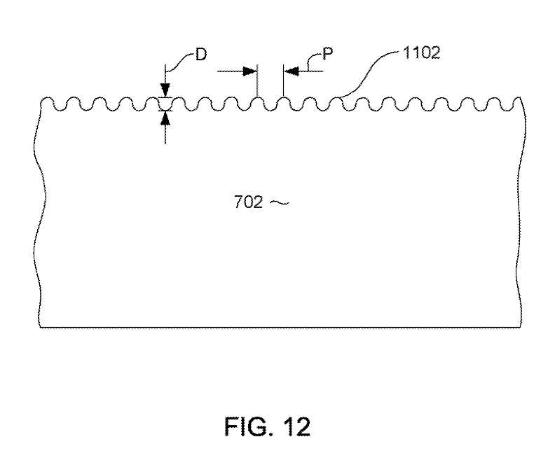

The angled ion milling induces anisotropic roughness, which may be in the form of, for example, oriented ripples or facets 802 which can be seen with reference to FIGS. 6 and 7. The typical or average pitch P of the ripples 1102 may be between about 1-200 nm, their average depth D may be between approximately 0.2 to 5 nm or about 0.5 nm. Although shown as uniform ripples in FIGS. 11 and 12, this is for purposes of illustration. The actual surface would more likely be in the form of a more random and irregular surface roughness that is generally oriented and configured as described. After the angled ion milling 802 has been performed sufficiently to form the desired ripples or facets 1102, the CrMo layer 902 may be deposited. The hard bias layer 904 can then be formed by depositing high coercivity magnetic material such as, for example CoPt or CoPtCr. Depending on the material being treated and the manufacturing conditions, the magnetic easy axis 352 (FIG. 3), of the applied hard bias layer 904 (338 in FIG. 3) may be substantially perpendicular to the in plane projection 1104 (FIG. 11) of the angled ion beam 802 onto the surface of the buffer layer 702. Under certain manufacturing conditions and materials being treated the magnetic easy axis may be either substantially parallel or substantially perpendicular to the in-plane projection 1104 of the angled ion beam 802. The direction of the ion milling must be chosen such that the resulting magnetic easy axis of the hard magnetic bias layers is substantially parallel to the ABS.

The exact voltage, current, and angle conditions for the ion milling 802 depend on the type and characteristics of the ion source in use. However, the ion milling 802 is preferably performed at the angle, voltage and duration described above.

It will be appreciated that various embodiments have been described above. These different embodiments have slightly different properties and serve different functions so that the choice of which embodiment to use depends upon design requirements. For example, with reference to FIG. 3, if the buffer layer 346 is constructed of Ru (for example 60 Angstroms thick), the hard bias layer 338 can have a coercivity of 1150 Oe and a squareness ratio of 3:4. On the other hand, if the buffer layer 346 is constructed of 60 CrMo (for example 60 Angstroms thick), the hard bias layer 348 can have a higher coercivity of 1836 and a lower squareness ratio of 1:3. With reference to FIG. 4, if the bi-layer buffer layer 404 is constructed of a 60 Angstrom layer of CrMo 406 and an 80 Angstrom layer of Ru, the hard bias layer 338 can have a coercivity of 1688 and a squareness ration of 1.6.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetoresistive sensor, comprising:
a sensor stack that includes a magnetic pinned layer a magnetic free layer and a non-magnetic layer sandwiched between the pinned layer and the free layer, the sensor stack having first and second laterally opposed sides;
a bias structure formed adjacent to at least one of the first and second sides of the sensor stack the bias structure comprising;
a buffer layer;
a seed layer formed over the buffer layer, the seed layer having a body centered cubic (BCC) crystalline structure, and
a hard magnetic material (hard bias layer) formed over the seed layer such that the seed layer is sandwiched between the hard bias layer and the buffer layer; wherein
the buffer layer has a surface that is configured with an anisotropic texture that induces a magnetic anisotropy in the hard bias layer.

2. A magnetoresistive sensor as in claim 1 wherein the buffer layer has a thickness of 10 to 150 Angstroms.

3. A magnetoresistive sensor as in claim 1 wherein the buffer layer has a thickness of 10-150 Angstroms and the seed layer has a thickness of 10-200.

4. A magnetoresistive sensor, comprising;
a sensor stack that includes a magnetic pinned layer a magnetic free layer and a non-magnetic layer sandwiched between the pinned layer and the free layer, the sensor stack having first and second laterally opposed sides;
a bias structure formed adjacent to at least one of the first and second sides of the sensor stack the bias structure comprising:
a buffer layer comprising CrMo;
a seed layer comprising CrMo formed over the buffer layer, the seed layer having a body centered cubic (BCC) crystalline structure; and
a hard magnetic material (hard bias layer) formed over the seed layer such that the seed layer is sandwiched between the hard bias layer and the buffer layer; wherein
the buffer layer has a surface that is configured with an anisotropic texture that induces a magnetic anisotropy in the hard bias layer.

5. A magnetoresistive sensor as in claim 4 wherein the buffer layer has a thickness of 10-150 Angstroms.

6. A magnetoresistive sensor as in claim magnetoresistive sensor as in claim 4 wherein the buffer layer has a thickness of 10-150 Angstroms and the seed layer has a thickness of 10-200 Angstroms.

7. A magnetoresistive sensor as in claim 4 wherein the anisotropic surface texture is in the form of uniaxial facets.

8. A magnetoresistive sensor as in claim 4 wherein the anisotropic surface texture is in the form of uniaxial facets having an average pitch of 1 to 200 nm.

9. A magnetoresistive sensor as in claim 4 wherein the anisotropic surface texture is in the form of uniaxial facets having an average depth of 0.2 to 5 nm.

10. A magnetoresistive sensor as in claim 4 wherein the anisotropic surface texture is in the form of uniaxial facets having an average pitch of 1 to 200 nm and an average depth of 0.2 to 5 nm.

11. A magnetoresistive sensor, comprising:
a sensor stack that includes a magnetic pinned layer a magnetic free layer and a non-magnetic layer sandwiched between the pinned layer and the free layer, the sensor stack having first and second laterally opposed sides;
a bias structure formed adjacent to at least one of the first and second sides of the sensor stack the bias structure comprising;
a buffer layer comprising Ru;
a seed layer formed comprising CrMo formed over the buffer layer, the seed layer; and
a hard magnetic material (hard bias layer) formed over the seed layer such that the seed layer is sandwiched between the hard bias layer and the buffer layer; wherein
the buffer layer has a surface that is configured with an anisotropic texture that induces a magnetic anisotropy in the hard bias layer.

12. A magnetoresistive sensor as in claim 11 wherein the buffer layer has a thickness of 10 to 150 Angstroms.

13. A magnetoresistive sensor as in claim 11 wherein the seed layer has a thickness of 10 to 200 Angstroms.

14. A magnetoresistive sensor as in claim 11 wherein the buffer layer has a thickness of 10 to 150 Angstroms and the seed layer has a thickness of 10 to 200 Angstroms.

15. A magnetoresistive sensor as in claim 11 wherein the anisotropic surface texture is in the form of uniaxial facets.

16. A magnetoresistive sensor as in claim 11 wherein the anisotropic surface texture is in the form of uniaxial facets having an average pitch of 1 to 200 nm.

17. A magnetoresistive sensor as in claim 11 wherein the anisotropic surface texture is in the form of uniaxial facets having an average depth of 0.2 to 5 nm.

18. A magnetoresistive sensor as in claim 11 wherein the anisotropic surface texture is in the form of uniaxial facets having an average pitch of 1 to 200 nm and an average depth of 0.2 to 5 nm.

19. A magnetoresistive sensor, comprising:
a sensor stack that includes a magnetic pinned layer a magnetic free layer and a non-magnetic layer sandwiched between the pinned layer and the free layer, the sensor stack having first and second laterally opposed sides;
a bias structure formed adjacent to at least one of the first and second sides of the sensor stack the bias structure comprising;
a bi-layer buffer layer structure comprising a first sub-layer comprising CrMo and second sub-layer comprising Ru;
a seed layer comprising CrMo formed over the buffer layer, the seed layer having a body centered cubic (BCC) crystalline structure; and
a hard magnetic material (hard bias layer) formed over the seed layer such that the seed layer is sandwiched between the hard bias layer and the buffer layer; wherein
the second sub-layer of the buffer layer has a surface that is configured with an anisotropic texture that induces a magnetic anisotropy in the hard bias layer,

20. A magnetoresistive sensor as in claim 19 wherein the second sub-layer is sandwiched between the first sub-layer and the seed layer.

21. A magnetoresistive sensor as in claim 19 wherein the bi-layer buffer layer has a total thickness of 20 to 300 Angstroms.

22. A magnetoresistive sensor as in claim 19 wherein the seed layer has a thickness of 10 to 200 Angstroms.

23. A magnetoresistive sensor as in claim 19 wherein the bi-layer buffer layer has a thickness of 12 to 300 Angstroms and the seed layer has a thickness of 10 to 200 Angstroms.

24. A magnetoresistive sensor as in claim 19 wherein the anisotropic surface texture is in the form of uniaxial facets.

25. A magnetoresistive sensor as in claim 19 wherein the anisotropic surface texture is in the form of uniaxial facets having an average pitch of 1 to 200 nm.

26. A magnetoresistive sensor as in claim 19 wherein the anisotropic surface texture is in the form of uniaxial facets having an average depth of 0.2 to 5 nm.

27. A magnetoresistive sensor as in claim 19 wherein the anisotropic surface texture is in the form of uniaxial facets having an average pitch of 1 to 200 nm and an average depth of 0.2 to 5 nm.

28. A method for manufacturing a magnetoresistive sensor comprising:
forming a sensor stack having first and second laterally opposed sides;
depositing a buffer layer;
performing a low voltage angled ion milling to form an anisotropic surface texture on the buffer layer;
depositing a seed layer; and
depositing a hard magnetic material.

29. A method as in claim 28 wherein the buffer layer comprises CrMo and the seed layer comprises CrMo.

30. A method as in claim 28 wherein the buffer layer comprises Ru and the seed layer comprises CrMo.

31. A method as in claim 28 wherein the buffer layer comprises a layer of CrMo and a layer of Ru and the seed layer comprises CrMo.
